(19) United States
(12) Patent Application Publication
(10) Pub. No.: US 2004/0084880 A1
(43) Pub. Date: May 6, 2004

(54) Bag with luminous wheel installed thereon

(76) Inventor: Yong-Hun Kim, Goyang City (KR)

Correspondence Address: CHERYL H AGRIS PHD, PO BOX 806, PELHAM, NY, 10803, US

(21) Appl. No.: 10/284,764

(22) Filed: Oct. 31, 2002

(51) Int. Cl. B62B 1/00; B62B 7/02

(52) U.S. Cl. 280/652; 280/47.24

(57) ABSTRACT

The present invention relates to a safe suitcase which can prevent safety accidents caused by carelessness when a cart pedestrian passes by terminals, airports, general footways or other sites crowded with people and cars while drawing a bag that is equipped with wheels and filled with clothes, his or her belongings and so on at night, by enabling general pedestrians, people riding on bicycles, or drivers of motorcycles or cars around the cart pedestrian to easily distinguish the cart pedestrian by the brilliant luminescence of the wheels.

### FIELD OF THE INVENTION

The present invention relates to a safe suitcase which can prevent possible safety accidents caused by carelessness when a cart pedestrian passes by terminals, airports, general footways or other sites crowded with people and cars while drawing a bag that is equipped with wheels and filled with clothes, his or her belongings and so on at night, by enabling general pedestrians, people riding on bicycles, or drivers of motorcycles or cars around the cart pedestrian to easily distinguish the cart pedestrian by the brilliant luminescence of the wheels.

### BACKGROUND OF THE RELATED ART

When one goes to terminals or airports for traveling with carrying a cart loaded with a suitcase fully filled with clothes, one's belongings and the like, one may pass by quiet places with less people or some crowded places mixed with pedestrians, riders of bicycles, motorcycles or cars or go across a crosswalk.

Particularly, when passing by such a crowded place at night while drawing a cart on which a suitcase is rested, other pedestrians, riders of bicycles, or drivers of motorcycles or cars cannot easily distinguish the cart pedestrian, resulting in a high probability of the occurrence of safe accidents caused by carelessness. Therefore, when walking down or crossing a crosswalk while drawing a cart bag, the cart pedestrian needs to more look around considering the safe walking of other pedestrians and the danger of traffic accidents.

The carts using bright color frames like an aluminum having high light reflectivity or being colored for a better discrimination at night have a limitation in securing a safe walking at night. Therefore, it is necessary to find out a way to securing the safe walking of cart pedestrians at night.

In the meanwhile, some of general suitcases (including a knapsack) have wheels, but these wheels are only for a convenient moving and thus cannot be distinguished at night or at dark basements.

In addition, a personal cart made of aluminum has an advantage of convenience but also has a limitation in that it cannot be easily distinguished at night or at the places, such as basements and cannot be shouldered.

That is, a personal cart can carry hand luggage or rather heavier load but it itself cannot be shouldered.

Thus, carts cannot be used at uneven roads or raised spots, particularly when passing by steps or slopes.

As described above, it is impossible to carry heavy loads with the use of conventional carts at the places where personal carts cannot be used due to the limitation of the landform.

### SUMMARY OF THE INVENTION

Accordingly, an object of the present invention is to provide a safe suitcase which can prevent accidents caused by carelessness when a cart pedestrian passes by terminals, airports, general footways or the other sites crowded with people and cars while drawing a bag that is equipped with wheels and filled with clothes, his or her belongings and so on at night, by enabling general pedestrians, people riding on bicycles, or drivers of motorcycles or cars around the cart pedestrian to easily distinguish the cart pedestrian by the brilliant luminescence of the wheels.

The above object can be obtained by the safe suitcase of the present invention wherein if a cart pedestrian uses shoulder straps after resting a suitcase having shoulder straps on a platform and retracting pulling rods, it is possible to carry heavy load more easily, and in the case of drawing the cart, the LEDs mounted on the coil box are conducted when coil terminals of the coil box in luminous wheels mounted at both sides of the strut side of the platform pass by corresponding parts of a mobile magnetic fixed to a wheel axle and thus emit brilliant lights, enabling a safe walking of a cart pedestrian in crowded places with an easy notice by general pedestrians, riders of bicycles, or drivers of motorcycles or cars.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a perspective view showing a safe suitcase cart according to the present invention;

FIG. 2 illustrates an exploded view showing a luminous wheel excluding a tire;

FIG. 3 illustrates a side view showing the luminous wheel;

FIG. 4 illustrates a cross sectional view taken along the line I-I of FIG. 3;

FIG. 5 illustrates a side view showing a suitcase;

FIG. 6 illustrates a partially cut away side view of FIG. 5;

FIG. 7 illustrates an example of the state in which the cart with the suitcase is carried on the shoulder; and

FIG. 8 illustrates a side view showing the suitcase when it is being drawn.

### DETAILED DESCRIPTION OF THE PREFERRED EMBODIMENT

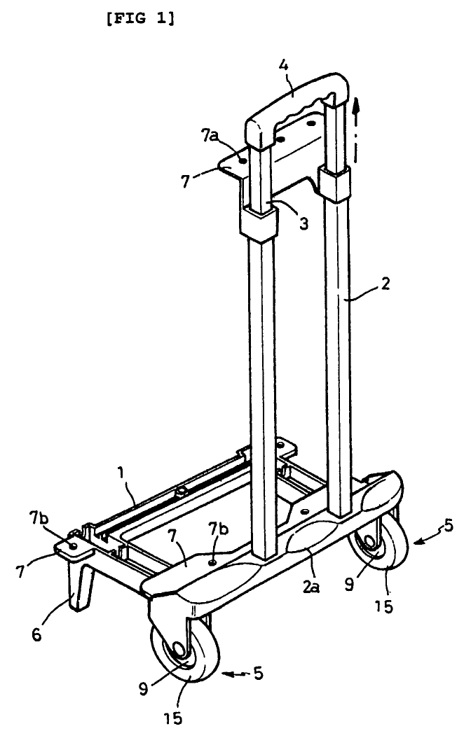

In FIG. 1, a cart A applied to a safe suitcase of the present invention comprises a platform 1, struts 2, a central frame 2a, pulling rods 3 having a handle 4, legs 6 for rear support of the platform 1, upper and lower fixing plates 7, and fixing holes 7a and 7b for a suitcase. Luminous wheels 5 having a mobile magnetic, a coil box, a coil and LEDs (Light Emission Diode) are mounted at both sides of the central frame 2a of the cart A.

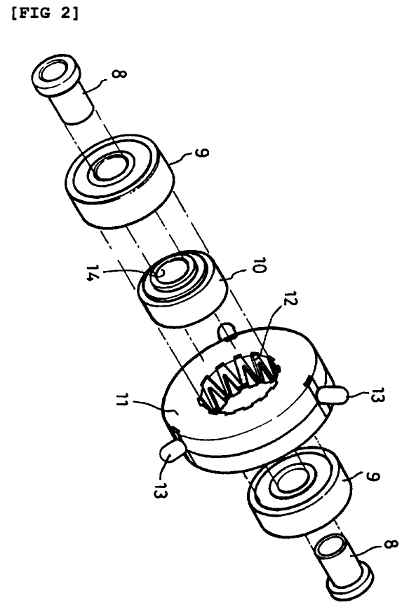

In FIG. 2, the luminous wheels 5 emit lights from the inside thereof when they are rolled. That is, the luminous wheel 5 has bushings 8 which are respectively inserted to the extent obtained by dividing a wheel axis (not shown) into two for its convenience, bearings 9 which are respectively inserted to the bushings 8, a mobile magnetic 10 which is tightly fixed to the front ends of the bushings 8 which passed through the bearings 9, a coil box 11 which has a coil 12 for power generation on its inner circumference and a plurality of LEDs 13 on its outer circumference, and a tire made of hard transparent resin which is combined with the outside of the coil box 11.

The mobile magnetic 10 is of doughnut shape and is made by inserting a doughnut-shaped magnetic into a tube-shaped sleeve 14 at its center. The sleeve 14 is closely inserted to the bushings 8, and is grounded when the cart is moved in a fixed state of the sleeve 14 to the wheel axle in the wheel 5, and the LEDs 13 are lighted by connecting/disconnecting the positive (+) and negative (−) electrodes of the coil box 11 which is rotated according to the rotating tire.

The coil 12 is placed at a core which is formed in a zigzag-shape in an inner circumference of the nonconductor coil box 11, and plays an important role of lighting the LEDs 13 by minute currents generated according to a private power generation principle when it is rotating around the mobile magnetic 10.

The plurality of LEDs 13 have different luminous colors, and thereby it is possible to focus the eyes of night pedestrians and drivers in an instant.

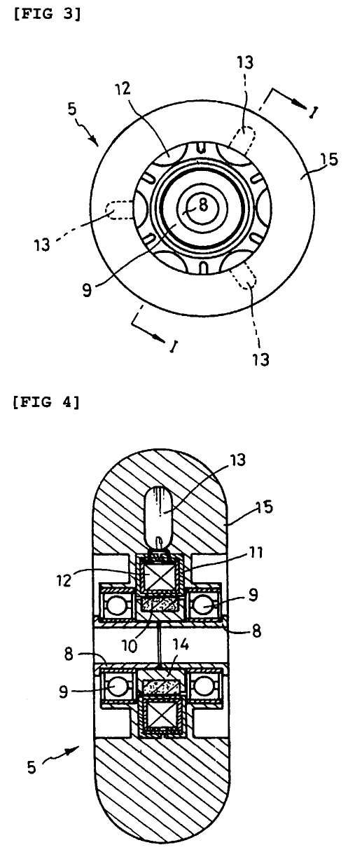

Referring to FIGS. 3 and 4, firstly, the bearings 9 are inserted to both bushings 8, the mobile magnetic 10 is loosely inserted to the center of the coil box 11 assembled with the coil 12 and the LEDs 13, and then the mobile magnetic 10 is inserted to the bushing 8.

Next, the other side of the mobile magnetic 10 is inserted to the other bushing 8 to which the other bearing 9 is inserted and a pressure is applied to the direction of the axle to make the mobile magnetic 10 not be moved on the bushings 8. The mobile magnetic 10 fixed to the bushings 8 are mounted in a wheel molding, and a tire 15 is molded by injecting the transparent resin.

If the tire 15 is molded as described above, the outer rings of the bearings 9 and the coil box 11 including the LEDs 13 are filled in the tire 15 and thus are united to the tire 15, while the inner rings of the bearings 9 and the bushings 8 are separated from the tire 15.

When the cart A having the luminous wheels 5 as described above is pulled, the tire 15, the coil box 11 and the LEDs 13 are rolled as it is pulled. At this time, the coil 12 is rotated around the mobile magnetic 10 to generate the positive (+) and negative (−) electrodes of the coil box 11 and thereby the LEDs 13 respectively connected to the positive and negative electrodes are lighted.

The brilliant lights from the LEDs 13 are projected to the transparent tire. Thus, it works its prominent function in that the cart is easily noticed by other pedestrians or drivers of bicycles, motorcycles or cars when the cart pedestrian passes by the place requiring a special attention for a safe pedestrian due to the crowded people and cars, such as terminals, airports, hotels and markets especially at night and the place like dark underground parking lots even in the daytime, thus avoiding the collision.

Therefore, it is possible to safely pull the cart A loaded with a suitcase even at night and at dark places.

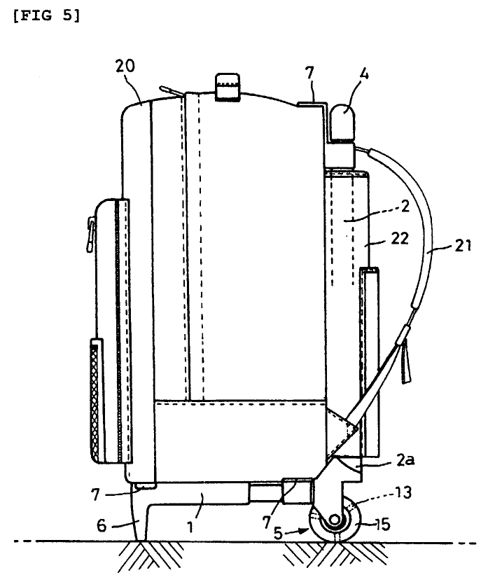

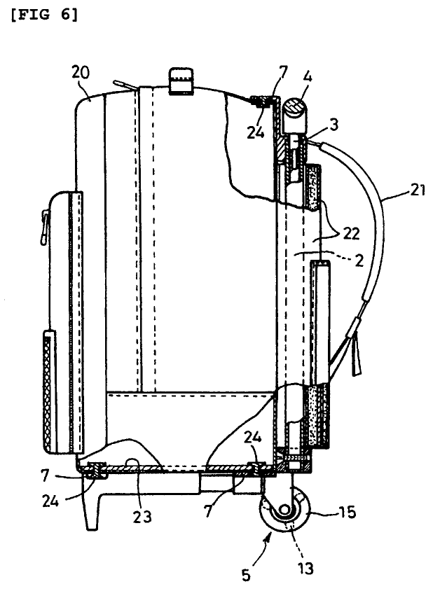

In FIG. 5, a suitcase 20 to which shoulder straps 21 are attached is suitable to the cart A. A band 22 the upper and lower ends of which are opened is attached to the front side of the suitcase 20 to cover the struts 2, thereby enabling the suitcase 20 to be stably fixed to the cart A.

The upper and lower ends of the shoulder straps 21 are respectively fixed to the upper and lower ends of the front side of the suitcase 20 at both sides of a pad sheet 22 for protecting the back.

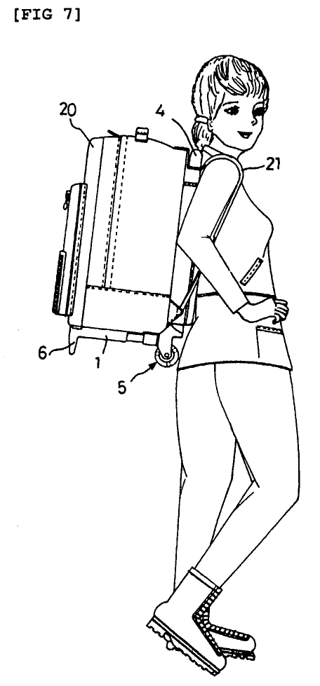

In FIG. 6, the bottom of the suitcase 20 is made of a box-shaped frame 23 of hard synthetic resin, and attaching holes corresponding to the fixing holes 7a and 7b are formed at the bottom of the frame 23.

The cart A and the suitcase 20 are united by corresponding the attaching holes to the fixing holes 7a and 7b of the platform 1 and then fixing them by a rivet 24 for settling the suitcase 20.

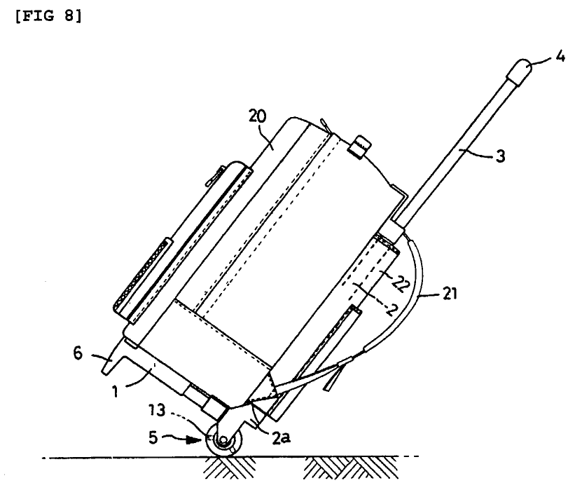

In FIG. 7, when a cart user goes to the places where it is difficult to pull the cart A loaded with the suitcase 20, for example, slopes, steps or mountains or when the cart user uses buses, air planes, subways or trains, the cart user can move more conveniently by using the shoulder straps 21.

In FIG. 8, in normal times, the cart user pulls the cart A after extending the pulling rods 23 from the struts 2 to the extent suitable to his or her height.

As described above, the present invention is advantageous in that when the cart is pulled, especially at night with heavy suicases, brilliant lights are flashed from the luminous wheels and it can be easily noticed by other people, enabling safe pedestrian and safe driving.

Further, when it is impossible to pull the cart loaded with the suitcase, for example, at the slopes, mountains, uneven roads, trains, air plains or other sites, it can be conveniently moved by being shouldered.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

Various references are cited herein, the disclosures of which are incorporated by reference in their entireties.

What is claimed is:

1. A safe suitcase having a platform for loading hand luggage, struts mounted on said platform, wheels mounted at both sides of the strut side of said platform and a suitcase which is to be mounted on said platform and has a band to cover said struts; comprising:
said suitcase having shoulder straps attached to the front side thereof; and
a cart having private power generation type luminous wheels where positive and negative terminals of a coil in a coil box which rotates according to a transparent tire are turned on and off when rotating around a mobile magnetic fixed to a wheel axle, and thus a plurality of LEDs emit lights.

2. The safe suitcase as claimed in claim 1, wherein said luminous wheels are made such that said transparent tire is formed to be united to the outer surface of said coil box and thereby the lights from the LEDs are projected to the outside.

3. The safe suitcase as claimed in claim 1, wherein said LEDs have different colors and are attached to the circumference of said coil box.
